(19) United States
(12) Patent Application Publication
(10) Pub. No.: US 2026/0284722 A1
(43) Pub. Date: Sep. 24, 2026

(54) DEVICE FOR REMOVING DUST FROM PREFORMS

(71) Applicant: SIDEL PARTICIPATIONS, Octeville-sur-Mer (FR)

(72) Inventor: Marc MOUCHELET, OCTEVILLE- SUR-MER (FR)

(21) Appl. No.: 19/572,979

(22) Filed: Mar. 20, 2026

(30) Foreign Application Priority Data
Mar. 21, 2025 (FR) 2502934

(51) Int. Cl. B08B 9/093; B08B 9/20; B08B 9/42; B29C 49/42

(52) U.S. Cl. CPC B08B 9/093; B08B 9/205; B08B 9/42; B29C 49/4252; B08B 2209/08

(57) ABSTRACT

Described is a device for removing dust from inside preforms by injection of gas. The device can include a conveying device having holding members for holding the preforms and at least one injection tube mounted on a mobile support so as to be able to be moved while being coincident with a holding member. Each injection tube can be mounted with the ability to slide axially on the mobile support by means of a carriage between an active axial position inserted into a preform and a retracted axial position. The device also includes mobile sensing elements for detecting the presence of a carriage in a determined first axial position, with each mobile sensing element being mounted on the mobile support.

### CROSS-REFERENCE TO RELATED APPLICATIONS

This application claims the benefit of French Application No. FR2502934, filed Mar. 21, 2025, the entire contents of which is hereby incorporated herein by reference.

### BACKGROUND

Examples of devices for removing dust from inside preforms made of thermoplastic material by injection of a pressurized gas are known from the prior art. Preforms made of thermoplastic material are intended for the manufacture of containers, such as bottles, vials, pots, etc. Preforms are generally manufactured by injection molding of thermoplastic material prior to their conversion into containers, generally at a different industrial site. The preforms are then transported in bulk from their manufacturing site to their conversion site and more often than not are stored at each of them.

Consequently, it has been found that various types of dust were then liable to penetrate the interior of the preforms. “Dust” is understood to mean, in a non-limiting manner, fine particles of material, such as specks of dust, but also pieces of packaging such as cardboard, etc., or thermoplastic material, notably but not exclusively in the form of filaments.

To manufacture containers, preforms are thermally conditioned in a thermal conditioning unit in order to soften the material of the body by heating to a temperature which then allows conversion thereof, by blow-molding or stretch-blow-molding, in one of the molds of a shaping unit. The containers obtained are then intended to be filled with various products the quality of which requires that the container be clean before it is filled. It is therefore known practice to remove dust from the preforms before shaping them.

To do this, the dust-removal device comprises injection means made up of tubes which are able to inject compressed air into the preform. The injection tube is mounted on a carriage sliding axially with respect to the preform, between a retracted axial position “P0” and an active axial position “P1” in which at least a part of the tube is inserted inside the preform.

In order to allow containers to be produced at a high production rate, the preforms are constantly in motion through the plant. Thus, the dust-removal device is equipped with a preform conveying device. The operation of removing dust is performed while the preforms are being conveyed. In order to avoid any collisions between the tubes and the preforms, it is absolutely essential for the injection tubes to be able to be operated in synchrony with the flow of the preforms. Furthermore, in order to ensure that the containers obtained are clean, it is also important to ensure that the tubes are indeed in their active axial position “P1” during the dust-removal operation.

To this end, it is known practice for fixed sensing elements to be installed for detecting the axial position of the injection tubes. These sensing elements are fixed relative to the floor to detect the axial position of each carriage successively, as it enters a determined detection zone along its path. Each fixed sensing element is thus common to all the carriages.

It is notably known practice for the dust-removal device to be equipped with a first fixed sensing element which detects when a carriage is occupying its active axial position “P1”, and with a second fixed sensing element which detects when a carriage is occupying its retracted axial position “P0”. However, if the command to move a carriage should fail, such a solution is not able to identify quickly which carriage it is that is presenting a problem.

Furthermore, it was known practice to command the sliding of the carriages in a dependent manner, by using a common cam. Such a control means makes it possible to achieve a dust-removal method or cycle that is referred to as “simple” wherein each tube is commanded to move into its active axial position “P1” at the start of the dust-removal method, then pressurized air is injected into the preform, before finally the injection tube is commanded to move once again, into its retracted axial position “P0”. In such a “simple” cycle, each injection tube is thus commanded once to move into its active axial position “P1” and once to move into its retracted axial position “P0”.

It has recently been proposed that such a control means be replaced by individual actuators specific to each carriage. Thus, each carriage can be commanded to slide independently of the others. An individual actuator such as this notably makes it possible to achieve dust-removal cycles that are more effective and more “complex” than those performed by means of cams. In such “complex” dust-removal cycles, each dust-removal tube can be commanded to move into its active axial position “P1” and into its retracted axial position “P0” a number of times during the course of the one same cycle of removing dust from the one same preform. It is additionally possible to adapt the dust-removal method to suit the production rate of the production plant.

In this context, the fixed sensing elements are unable to guarantee that “complex” dust-removal methods are progressing correctly. Furthermore, the response time of the actuators may begin to lengthen, notably as a result of normal wearing of certain components, or in the event of a malfunction. Now, a fixed sensing element is unable to check the response time of each individual actuator. Accordingly, it has been found that needs exist for an improved dust removal device with non-fixed sensing elements. It is to the provision of meeting these and other needs that the present invention is primarily directed.

### SUMMARY

Embodiments of the present disclosure provide for devices and methods for dust removal.

An embodiment of the present disclosure includes a device for removing dust from inside preforms made of thermoplastic material by injection of treatment gas. The device can include a conveying device comprising holding members for holding the preforms, where the members are mobile along a closed circuit. The device can also include injection tubes, each of which is mounted on a mobile support so that the injection tubes can be moved while being coincident with an associated one of the holding members along the closed circuit. Each injection tube can slide axially on the mobile support via a carriage that slides between an active axial position in which each injection tube can be inserted into a preform carried by the associated holding member, and a retracted axial position in which the injection tube can be outside of a preform carried by the associated holding member. The device can also include mobile sensing elements for detecting a presence of an associated carriage in a determined first axial position. Each mobile sensing element can be mounted on the mobile support. Each mobile sensing element can constantly check, over an entire length of the closed circuit, whether the associated carriage is occupying the determined first axial position.

An embodiment of the present disclosure also includes a method for removing dust from inside a preform using a device as provided above. The method can include an initial step of commanding the carriage carrying the injection tube associated with the preform to move into its active axial position in which the injection tube is inserted into the preform carried by the holding member. The method can also include a final step of commanding the carriage carrying the injection tube associated with the preform to move into its retracted axial position in which the injection tube is completely extracted from the preform carried by the holding member.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a view from above which schematically shows a dust-removal device produced according to various example embodiments;

FIG. 2 is a perspective view that schematically shows the dust-removal device of FIG. 1, though for the sake of clarity only some of the injection tubes of the device are shown;

FIG. 3 is a perspective view from the rear, showing one of the dust-removal stations with which the dust-removal device of FIG. 1 is equipped;

FIG. 4 is a view in section on the plane of section 4-4 of FIG. 1, and schematically shows a dust-removal station in which the injection tube is occupying its retracted position;

FIG. 5 is a view in section on the plane of section 5-5 of FIG. 1, and schematically shows a dust-removal station in which the injection tube is occupying its active position;

FIG. is a diagram which shows, on the abscissa axis, the position of a dust-removal station of the dust-removal device of FIG. 1, along its closed circuit, and, on the ordinate axis on the left, the axial position of the injection tube and, on the ordinate axis on the right, the command for the injection tube to inject pressurized air, the diagram showing the operation of the dust-removal device operating on a simple dust-removal cycle; and

FIG. 7 is a diagram similar to that of FIG. 6 showing the operation of the dust-removal device operating on a complex dust-removal cycle according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

### Definitions

“Sensing element” as used herein, can include sensing elements as can be readily understood by a person having ordinary skill in the art. Sensing elements, in non-limiting examples, can include contact sensors, such as a switch or non-contact sensors such as a magnetic sensor, a photoelectric sensor or an inductive proximity sensor.

### General Discussion

In accordance with the purpose(s) of the present disclosure, as embodied and broadly described herein, embodiments of the present disclosure, in some aspects, relate to

In general, embodiments of the present disclosure provide for dust removal devices and methods for removing dust from inside preforms.

An embodiment of the present disclosure includes a device for removing dust from inside preforms made of thermoplastic material, by injection of treatment gas. The device can include a conveying device having holding members for holding the preforms, where the members are mobile along a closed circuit. The device can also include injection tubes, each of which is mounted on a mobile support so that they can be moved while being coincident with an associated one of the holding members along the closed circuit. Each injection tube can be mounted with the ability to slide axially on the mobile support by a carriage that slides between an active axial position in which the injection tube is can be inserted into a preform carried by the associated holding member, and a retracted axial position in which the injection tube can be outside of a preform carried by the associated holding member. The device also includes mobile sensing elements for detecting the presence of an associated carriage in a determined first axial position. Each mobile sensing element can be mounted on the mobile support and each mobile sensing element constantly, over the entire length of the circuit, checks whether the associated carriage is occupying the determined axial position.

According to other features of the dust-removal device described herein, at least one of the mobile sensing elements detects the presence of the carriage in its retracted axial position. At least one of the mobile sensing elements detects the presence of the carriage in an intermediate axial position somewhere between its active axial position and its retracted axial position. At least one of the mobile sensing elements detects the presence of the carriage in its active axial position. Each carriage is controlled by an associated independent actuator. A plurality of injection tubes is fixed on each carriage. The device also includes a fixed sensing element for detecting the presence of each carriage in a determined axial position when the carriages enter a detection zone of the closed circuit. The fixed sensing element detects the presence of each carriage in its active axial position. The retracted axial position is fixed whereas the active axial position is adjustable according to the model of preform being processed by the dust-removal device.

The invention also relates to a method for removing dust from inside a preform and implementing the dust-removal device according to the teachings of the invention. The method can include at least an initial step of commanding the carriage carrying the injection tube associated with the preform to move into its active axial position in which the injection tube is inserted into the preform carried by the holding member and a final step of commanding the carriage carrying the injection tube associated with the preform to move into its retracted axial position in which the injection tube is completely extracted from the preform carried by the holding member. The method can also include at least the following steps inserted chronologically after the initial step and before the final step: a first intermediate step of commanding the carriage carrying the injection tube associated with the preform to move into its retracted axial position in which the injection tube is completely extracted from the preform carried by the holding member, and a second intermediate step of commanding the carriage carrying the injection tube associated with the preform to move into its active axial position in which the injection tube is inserted into the preform carried by the holding member.

According to other features of the method performed according to the teachings of the invention, pressurized air is injected into the preform using the injection tube at the end of the initial step. The pressurized air is injected continuously up to the start of the final step. The pressurized air is injected discontinuously between the end of the initial step and the start of the final step. The pressurized air is injected only when the carriage is occupying its active axial position.

Turning now to the drawings, exemplary embodiments are described in detail.

The remainder of the description will, in a non-limiting manner, adopt an axial orientation parallel to an axis “Z0” of a preform 22 carried by a holding member 34 of the dust-removal device 20 and directed from bottom to top according to the arrow “A” in the figures. In the examples depicted in the figures, the axial direction corresponds, non-limitingly, to the direction of gravity.

Also defined is a horizontal plane which is orthogonal to the axial direction.

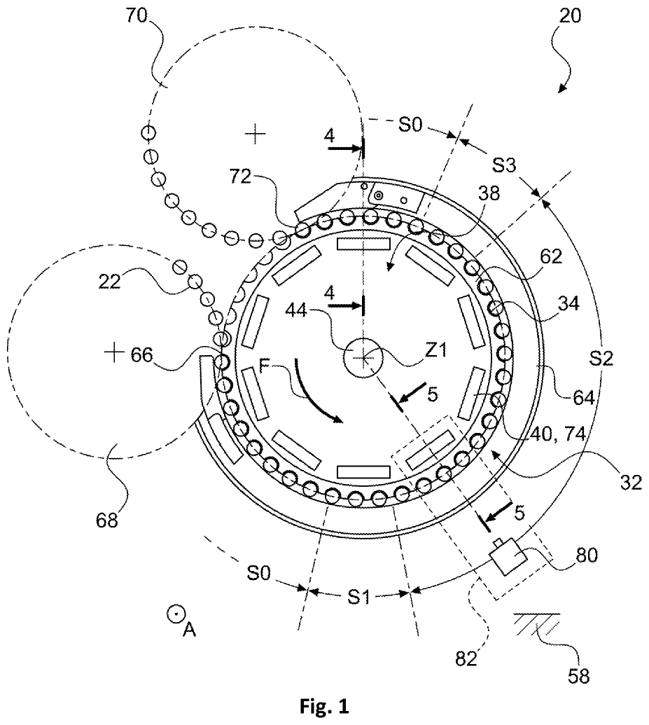

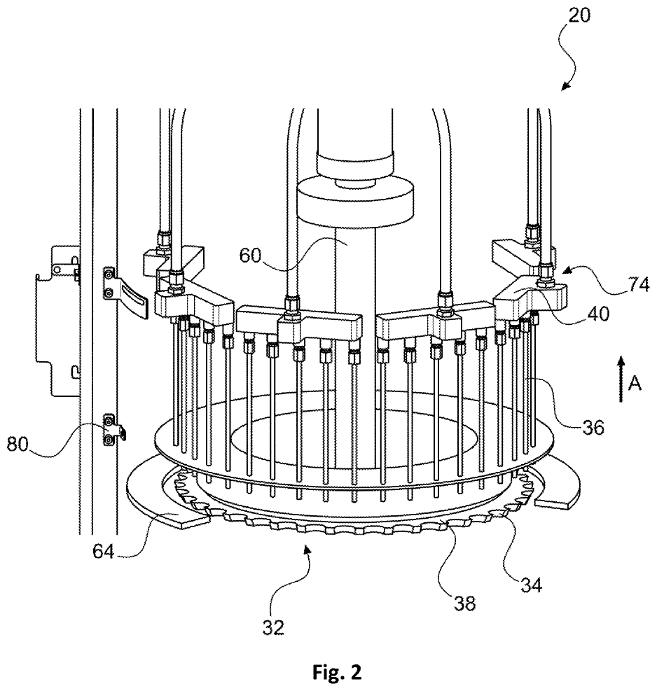

FIGS. 1 and 2 show a device 20 for removing dust from inside preforms 22 made of thermoplastic material by injection of a pressurized gas. The pressurized gas is, for example, air.

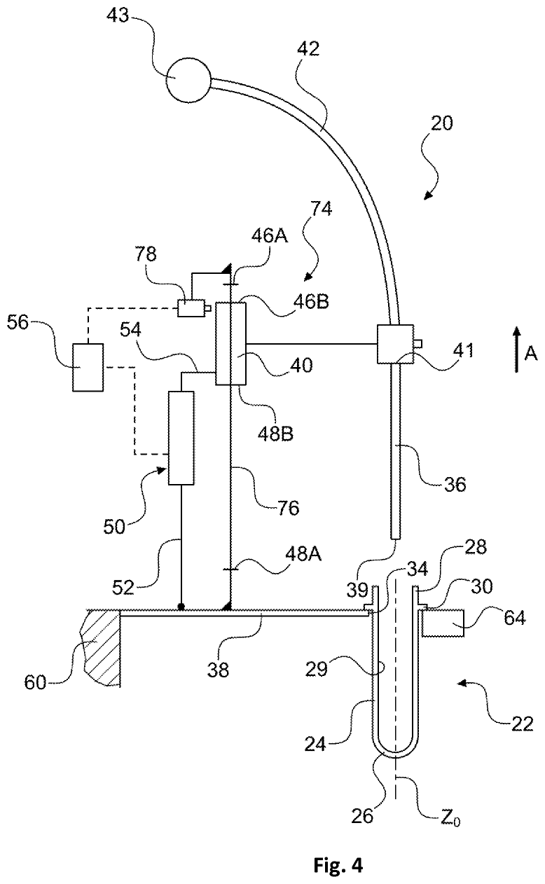

Such a preform 22 is shown in FIG. 4. Said preform is made of thermoplastic material, in this case of polyethylene terephthalate (PET). It is conventionally obtained by injection molding. It has a shape which is substantially axisymmetric about a main axis “Z0” of vertical orientation.

As shown in FIG. 4, it has a cylindrical body 24 with tubular wall, said body being closed at its lower end by a bottom 26 and being extended at its upper end by a neck 28 which is open axially toward the top, and which is also tubular. An internal face 29 of the wall delimits the interior of the preform 22. The neck 28 is generally injection-molded in such a way as to already have its definitive shape, whereas the body 24 of the preform 22 is intended to be subjected to a relatively significant deformation to form the final container during a subsequent shaping step.

The neck 28 of the preform 22 also comprises an annular ring 30 which protrudes radially. The ring 30 is in this case arranged at the junction between the base of the neck 28 and the body 24.

Such a dust-removal device 20 is for example incorporated into a plant for manufacturing containers by blow-molding or stretch-blow-molding preforms 22. It is for example arranged upstream of a thermal conditioning unit the purpose of which is to heat the body 24 of the preforms 22 beyond the glass transition temperature to allow them subsequently to be shaped in a shaping unit. This is a manufacturing plant in which the preforms 22 are in constant movement in order to allow for large-scale mass production.

Thus, the dust-removal device 20 comprises a conveying device 32 for conveying the preforms 22. The conveying device 32 comprises holding members 34 for holding the preforms 22. The holding members 34 are mobile along a closed circuit.

The dust-removal device 20 also comprises injection tubes 36 each of which is mounted on a mobile support 38 so that they can be moved while being coincident with an associated one of said holding members 34 along the closed circuit. The dust-removal device 20 here comprises as many injection tubes 36 as there are holding members 34.

The mobile support 38 moves conjointly with the associated holding member 34. Thus, each holding member 34 moves while being coincident with an associated injection tube 36.

In the embodiment depicted in the figures, the holding members 34 are carried by the associated mobile support 38.

In the example depicted in the figures, and which will be described in greater detail hereinafter, all the injection tubes 36 are carried by the one same mobile support 38.

As a variant, not shown, of the invention, the dust-removal device 20 may comprise a plurality of distinct mobile supports able to move independently. Each mobile support may carry one or more injection tubes.

Each injection tube 36 here is a straight rigid tube which extends along an axis parallel to the axis “Z0” of a preform 22 carried by the associated holding member 34. The preform 22 carried by the holding member 34 is intended to have its neck 28 facing toward the injection tube 36.

Each injection tube 36 has a free lower end which is provided with an injection nozzle 39 and an upper end which is provided with a supply orifice 41 which is intended to be connected to a source 43 of pressurized dust-removal gas. The gas is for example at a pressure of 7 bar.

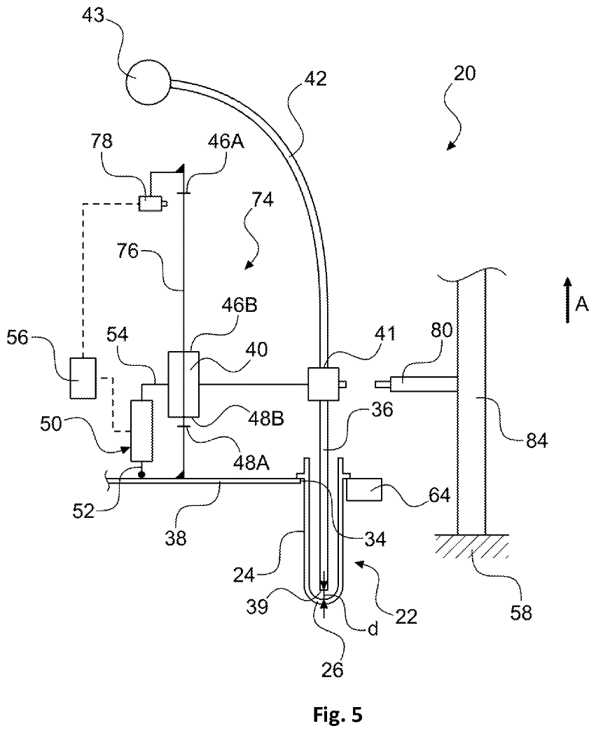

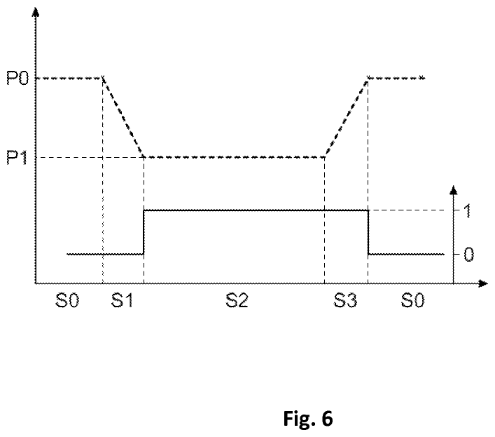

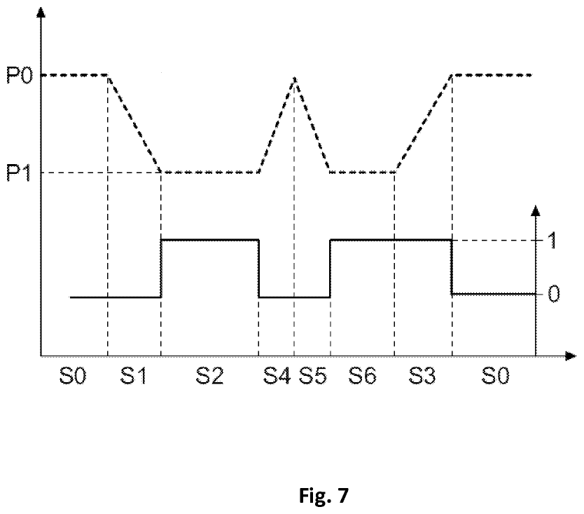

Each injection tube 36 is fixed to a carriage 40 sliding on the mobile support 38. Thus, each injection tube 36 is mounted with the ability to slide axially on the mobile support 38 by means of a carriage 40 that slides between an active axial position “P1” in which the injection tube 36 is inserted into the preform 22 carried by the associated holding member 34, as depicted in FIG. 5, and a retracted axial position “P0” in which the injection tube 36 is intended to be outside of a preform 22 carried by the associated holding member 34, as depicted in FIG. 4.

Each injection tube 36 is connected to the source 43 of pressurized gas, in this instance air, by means of a pipe 42 which is flexible, thus allowing the injection tube 36 to slide.

Furthermore, when the gas source 43 is fixed relative to the floor, each flexible pipe 42 may be connected to said gas source 43 by means of a rotary joint 44 or by any other suitable coupling member.

In its retracted axial position “P0”, depicted in FIG. 4, the injection tube 36 is aligned vertically over the opening of the neck 28 so that the injection tube 36 can enter said preform 22 via its neck 28 as it slides toward its active axial position “P1”. In this retracted axial position “P0”, the injection tube 36 is completely extracted from the preform 22 carried by the associated holding member 34 so as to allow the preform 22, from which any dust has been removed, to be transferred out of its holding member 34 by movement orthogonal to its axis “Z0” and a new preform 22 to be received in the holding member 34 by movement orthogonal to its axis “Z0”.

In the embodiment depicted in the figures, in the active axial position “P1”, an axial straight lower end portion of the injection tube 36 is intended to be inserted inside a preform 22, carried by its neck 28 by the associated holding member 34. In this active axial position “P1”, the injection nozzle 39 is arranged at a determined short distance “d” from the bottom 26 of the preform 22. The distance “d” is for example of the order of one millimeter. The distance “d” is selected in such a way as to allow the flow of pressurized gas injected by the nozzle 39 to expel the dust that has settled in the bottom 26 of the preform 22 and on the internal face 29 to outside the preform 22, leaving via the neck 28.

The dust-removal device 20 is intended to process preforms 22 of differing lengths. In order to do this, it is necessary to be able to adjust the sliding travel of the carriages 40 to prevent the injection tubes 36 from touching the bottom 26 of the preforms 22 or, on the other hand, from not being inserted deeply enough to achieve good dust removal. To this end, the retracted axial position “P0” is fixed whereas the active axial position “P1” is adjustable according to the model of preform being processed by the dust-removal device.

In the example depicted in the figures, the sliding travel of each carriage 40 is delimited in the upward direction by contact between an upper end stop 46A borne by the mobile support 38 and an upper stop face 46B borne by the carriage 40, and in the downward direction by contact between a lower end stop 48A borne by the mobile support 38 and a lower stop face 48B borne by the carriage 40. It is possible to vary the length of travel by moving the lower end stop 48A axially with respect to the mobile support 38 and/or by moving the lower stop face 48B axially with respect to the carriage 40.

Each carriage 40 here carries a plurality of injection tubes 36, for example six injection tubes 36. Thus, there are a plurality of injection tubes 36 fixed on each carriage 40.

In a variant, each carriage 40 may equally carry just one injection tube 36.

Each injection tube 36 here is mounted coaxially with respect to the axis “Z0” of the preform 22 carried by the associated holding member 34.

As a variant, each injection tube 36 is offset slightly from the axis “Z0” of the associated preform 22 but still aligned vertically over the opening of the neck 28 of the preform 22.

The sliding of each carriage 40 is controlled by at least one associated actuator 50, indicated schematically in FIGS. 4 and 5. For this purpose the actuator 50 comprises a fixed part 52 which is fixed to the associated mobile support 38 and a driving part 54 which is fixed to the carriage 40.

In the embodiment shown in the figures, each carriage 40 comprises a single actuator 50 which makes it possible simultaneously to command the sliding of all the injection tubes 36 carried by said carriage 40.

Such an actuator 50 is for example formed by an electric motor controlled by a rotary collector. As a variant, the actuator 50 is formed by an electric or pneumatic actuating cylinder or by any other known and suitable drive means.

The actuator 50 is controlled automatically by an electronic control unit 56. It is commanded for example according to the location of the carriage 40 along the closed circuit.

The dust-removal device 20 thus enables the preforms 22 to have their dust removed while they are being conveyed.

In the non-limiting example depicted in FIG. 1, the mobile support 38 is formed by a carousel mounted with the ability to rotate with respect to the floor 58 about an axial central axis “Z1”.

The mobile support 38 is more particularly driven in continuous rotation, in this case in an anticlockwise direction as indicated by the arrow F in FIG. 1, by an axial shaft 60 of central axis “Z1”, visible in FIG. 2, for example by means of an electric motor (not shown).

The mobile support 38 carries the holding members 34 for holding the preforms 22. As a result, the closed circuit has a circular shape. The holding members 34 allow the preforms 22 to be driven one after another along a common path in the form of an arc of a circle centered on the central axis “Z1”.

The holding members 34 are in this case formed by semicircular notches made in the outer periphery of a ring 62. The ring 62 is mounted fixed on the mobile support 38. Each holding member 34 makes it possible to accommodate that part of the body 24 of the preform 22 which is situated just below the transfer ring 30, whereas the transfer ring 30 rests on an upper face of the ring 62 thus allowing the preform 22 to be driven along its path.

In a variant of the invention that is not shown, the holding members are formed by grippers which grip each preform just above or just below their transfer ring.

To prevent the preforms 22 from falling under the effect of centrifugal force during the rotation of the mobile support 38, an arched guide 64, which is fixed with respect to the floor 58, is arranged along the circular-arc path of the preforms 22. The preforms 22 thus slide along the guide 64 which makes it possible to retain them radially inside their associated holding members 34.

The ring 62 comprises, for example, thirty-two or forty-two holding members 34 which are distributed evenly around its periphery. The dust-removal device 20 is designed to enable the transport of and removal of dust from a high throughput of preforms 22, for example of the order of 60,000 preforms per hour.

As shown in FIG. 1, the preforms 22 are conveyed as far as an inlet 66 of the dust-removal device 20 by an input wheel 68 which is indicated schematically by a circle in FIG. 1. The preforms 22 are transferred, after any dust has been removed, onto an output wheel 70 which is indicated schematically by a circle in FIG. 1, at an outlet 72. The input wheel 68 and output wheel 70 are, for example, wheels with notches having holding members similar to the holding members 34 of the mobile support 38. Between the inlet 66 and the outlet 72, the path of the preforms 22 extends in this case over an angular sector greater than 180°, for example of the order of 300°.

The mobile support 38 is also equipped with several dust-removal stations 74 which make it possible for any dust to be removed from the preforms 22 as they are being transported from the inlet 66 to the outlet 72. Each dust-removal station 74 is carried on the mobile support 38, that is to say that each dust-removal station 74 is driven in rotation about the central axis “Z1” conjointly with the mobile support 38.

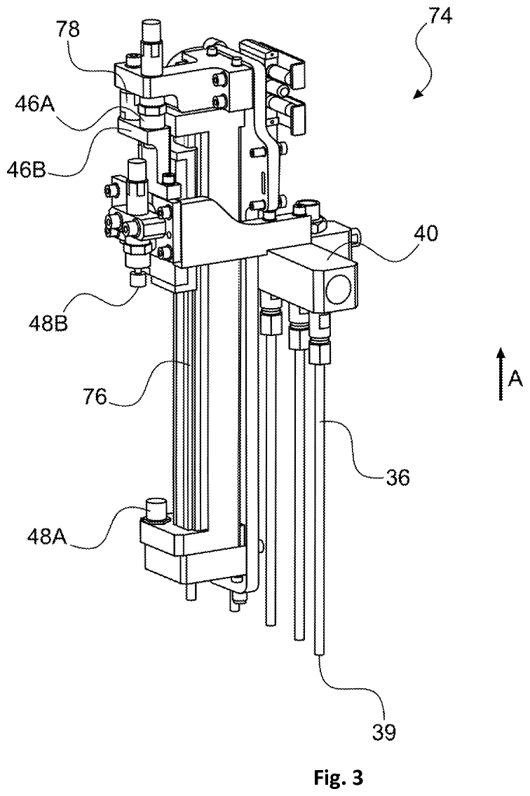

As is shown in FIGS. 2 and 3, each dust-removal station 74 comprises at least one of the injection tubes 36 which is carried on the mobile support 38. Each injection tube 36 is arranged axially in register with one of the holding members 34. Thus, the mobile support 38 comprises as many injection tubes 36 as there are holding members 34.

In the embodiment depicted in the figures, each dust-removal station 74 comprises six injection tubes 36.

As depicted in FIG. 3, the injection tubes 36 of the one same dust-removal station 74 are fixed to a common carriage 40. The carriage 40 here is mounted with the ability to slide on the mobile support 38 by means of an axial guideway 76. Here, the guideway 76 is fixed to the mobile support 38. This sliding connection has been indicated by kinematics diagrams in FIGS. 4 and 5.

The lower stop face 48B here is borne by a screw which is screwed axially onto the carriage 40 so that its axial position with respect to the carriage 40 can easily be modified by screwing it further in or by unscrewing it.

Whatever the embodiment variant selected, the dust-removal device 20 comprises mobile sensing elements 78 for detecting the presence of an associated carriage 40 in a determined first axial position.

In the embodiment depicted in the figures, each mobile sensing element 78 is able to detect the presence of an associated carriage 40 only in a determined first axial position.

In other words, the mobile sensing element 78 is unable to detect the position of the carriage outside of this determined axial position. This makes it possible to reduce the cost of manufacture of the dust-removal device 20.

Each carriage 40 is associated with a mobile sensing element 78. Each mobile sensing element 78 is mounted on the mobile support 38 and thus moves conjointly with the carriage 40 along the closed circuit.

Thanks to this arrangement, each mobile sensing element 78 constantly, over the entire length of the circuit, checks whether the associated carriage 40 is occupying said determined first axial position. This then makes it possible to individually monitor whether each actuator 50 is operational and/or to monitor the response time of each actuator 50 and/or to perform complex dust-removal methods as will be explained hereinafter.

Each mobile sensing element 78 here is capable of detecting whether the carriage 40 is occupying its determined first axial position or whether it is not occupying this determined first axial position.

Each mobile sensing element 78 is for example formed by a contact sensor, such as a switch, that is triggered when the carriage 40 is occupying its determined first axial position.

As a variant, not shown, of the invention, the mobile sensing element may also be a contactless sensor, such as a magnetic sensor, a photoelectric sensor or else an inductive proximity sensor.

Each mobile sensing element 78 is for example in communication with the electronic control unit 56 so that the latter can determine the response time of the actuator 50 and/or verify that the actuator 50 is operating correctly.

In the embodiment depicted in the figures, at least one of the mobile sensing elements 78 detects the presence of the carriage 40 in its retracted axial position “P0”. Here, each carriage 40 is associated with such a mobile sensing element 78. As depicted in FIGS. 4 and 5, the mobile sensing element 78 is fixed to an upper end of the guideway 76.

As a variant, not shown, of the invention, each carriage 40 may also be associated with at least one of the mobile sensing elements which detects the presence of the carriage in an intermediate axial position somewhere between its active axial position “P1” and its retracted axial position “P0”.

In the embodiment depicted in the figures, the dust-removal device 20 also comprises a fixed sensing element 80 for detecting the presence of each carriage 40 in a determined second axial position when the carriages enter a detection zone 82 of the circuit. The fixed sensing element 80 is thus mounted fixed relative to the floor 58.

Thus, the fixed member 80 successively checks that each carriage 40 is occupying its determined second axial position as these carriages successively enter the detection zone 82 of the closed circuit. The fixed checking member 80 is therefore common to all the carriages 40.

This offers the advantage that it is possible to detect that each carriage 40 is occupying its determined second axial position using just one fixed sensing element 80.

Said determined second axial position detected by the fixed sensing element 80 is in this case an axial position different than the determined first axial position detected by the mobile sensing elements 78.

In the embodiment depicted in the figures, the fixed sensing element 80 detects the presence of each carriage 40 in its active axial position “P1”.

This makes it possible for only the axial position of a single fixed sensing element 80 to need to be modified when modifying the axial travel of the injection tubes 36.

However, such an arrangement does not make it possible to constantly check whether each carriage 40 is occupying its active axial position “P1” outside of the detection zone 82 of the closed circuit.

As a variant, not shown, of the invention, each carriage 40 may also be associated with at least one mobile sensing element which detects the presence of the carriage in its active axial position “P1”. In this case, it is necessary to be able to vary the axial position of such a mobile sensing element when adjusting the active axial position “P1” of the injection tube 36.

The fixed sensing element 80 is in communication with the electronic control unit 56 so that the latter can determine whether each carriage 40 is indeed occupying its active axial position “P1” as it enters the detection zone 82.

As a preference, the fixed sensing element 80 is a contactless sensor, such as a magnetic sensor, a photoelectric sensor or else an inductive proximity sensor. Here it is mounted on a post 84 which is fixed with respect to the floor 58 and which is arranged facing the detection zone 82.

When the dust-removal device 20 is operating on a “simple cycle” dust-removal method, each injection tube 36 travels along the closed circuit which is divided, from upstream to downstream, into several sectors which are fixed with respect to the floor 58 and which have been indicated in FIG. 1. The operation of the dust-removal device 20 for a simple cycle is described for one injection tube 36, the description being applicable to each of the injection tubes 36 with reference to FIG. 6.

FIG. 6 depicts, on the abscissa axis, the location of the carriage 40 along the closed circuit, the dotted line being the axial position of the carriage 40 along its axis of sliding, and the solid line indicating the triggering of the injection of pressurized air.

Along a first sector, hereinafter called retracted primary sector “S0”, the carriage 40 and the associated injection tube 36 occupies its retracted axial position “P0”. Along this first, retracted primary sector “S0”, each preform 22 is received in one of the holding members 34 at the inlet 66, whereas the associated injection tube 36 remains in its retracted axial position “P0”.

The mobile sensing element 78 associated with the carriage 40 makes it possible to check that the carriage 40 remains in its retracted axial position “P0”.

There is then an initial step “Ei” of commanding the carriage 40 carrying the injection tube 36 associated with the preform 22 to move as far as its active axial position “P1” in which the injection tube 36 is inserted into the preform 22 carried by the holding member 34.

During this initial commanding step “Ei”, the mobile support 38 continues to move, bringing the injection tube 36 as far as a second sector, hereinafter called insertion primary sector “S1”, along which sector the injection tube 36 moves from its retracted axial position “P0” as far as its active axial position “P1”. This insertion primary sector “S1” extends, for example, over approximately 25°.

The mobile sensing element 78 makes it possible to check that the carriage 40 has indeed left its retracted axial position “P0”. It also makes it possible to determine the reaction time of the actuator 50 by detecting the moment at which the carriage 40 leaves its retracted axial position “P0” compared with the moment at which the command to move is sent by the electronic control unit 56 to the actuator 50.

At the end of the initial command step “Ei”, when the injection tube 36 has reached its active axial position “P1”, it enters a third sector of its closed circuit, hereinafter called inserted primary sector “S2”, along which each injection tube 36 remains in its active axial position “P1”.

The detection zone 82 is arranged in an upstream part of the inserted primary sector “S2” so that the fixed sensing element 80 can detect whether the carriage 40 is indeed occupying its active axial position “P1”.

Pressurized air is injected into the preform 22 using the injection tube 36 at the end of the initial step “Ei”.

The injection nozzle 39 then emits a continuous jet of pressurized treatment gas which expels any foreign bodies, notably dust, cardboard, sawdust, contained in the preform 22 to the outside by making it rise up along the internal face 29 of the preform 22 as far as the neck 28. The dust expelled from the preform 22 is then collected by a dust extractor (not shown) so as to avoid contaminating the other preforms 22. The inserted primary sector “S2” extends, for example, over approximately 120°.

The pressurized air is preferably injected continuously at least up to the start of a final step “Ef”. In the example depicted in FIG. 6, the pressurized air is injected continuously up to the end of the final step “Ef”.

During the final command step “Ef”, the carriage 40 carrying the injection tube 36 associated with the preform 22 is moved as far as its retracted axial position “P0” in which the injection tube 36 is completely extracted from the preform 22 carried by the holding member 34.

This final step “Ef” is triggered when the injection tube 36 reaches a fourth sector, hereinafter called retraction primary sector “S3”. The injection tube 36 then moves from its active axial position “P1” as far as its retracted axial position “P0”. This retraction primary sector “S3” extends, for example, over approximately 25°.

The mobile sensing element 78 makes it possible to check that the carriage 40 has indeed returned to its retracted axial position “P0”. It also makes it possible to determine the reaction time of the actuator 50 by detecting the moment at which the carriage 40 reaches its retracted axial position “P0” compared with the moment at which the command to move is sent by the electronic control unit 56 to the actuator 50.

When the injection tube 36 reaches its retracted axial position “P0”, it returns to the retracted primary sector “S0” of its path. The injection tube 36 reaches its retracted axial position “P0” before the preform 22 reaches the outlet 72 in order to allow the preform 22 that has thus undergone dust removal to be transferred to the output wheel 70.

The presence of the mobile sensing elements 78 nevertheless makes it possible to perform more complex dust-removal methods referred to as “complex cycles” that make it possible further to improve the effectiveness of the removal of dust from the preforms 22.

These complex cycles comprise all the steps of the simple cycle described hereinabove, although in this case provision is made for the injection tube 36 to be made to slide at least once as far as its retracted axial position “P0” and then as far as its active axial position “P1” between the initial step “Ei” and the final step “Ef”.

Such a complex cycle comprises at least the following steps inserted chronologically after the initial step “Ei” and before the final step “Ef”.

Thus, after the initial step “Ei” and a first air-injection operation, a first intermediate step “E1” is triggered. During this first intermediate step “E1”, the carriage 40 carrying the injection tube 36 associated with the preform 22 is commanded to move as far as its retracted axial position “P0” in which the injection tube 36 is completely extracted from the preform 22 carried by the holding member 34. The mobile sensing element 78 associated with the carriage 40 makes it possible to detect when the carriage 40 reaches its retracted axial position “P0”.

This first intermediate step “E1” is triggered when the injection tube 36 reaches a fifth sector, hereinafter called retraction intermediate sector “S4” situated between the inserted primary sector “S2” and the retraction primary sector “S3”. The injection tube 36 then moves from its active axial position “P1” as far as its retracted axial position “P0”. This retraction intermediate sector “S4” extends, for example, over approximately 25°.

The mobile sensing element 78 makes it possible to check that the carriage 40 has indeed returned to its retracted axial position “P0”. It also makes it possible to determine the reaction time of the actuator 50 by detecting the moment at which the carriage 40 reaches its retracted axial position “P0” compared with the moment at which the command to move is sent by the electronic control unit 56 to the actuator 50.

At the end of this first intermediate step “E1”, a second intermediate step “E2” is triggered. During this second intermediate step “E2”, the carriage 40 carrying the injection tube 36 associated with the preform 22 is commanded to move as far as its active axial position “P1” in which the injection tube 36 is inserted inside the preform 22 carried by the holding member 34.

During this second intermediate step “E2”, the mobile support 38 continues to move, bringing the injection tube 36 as far as a sixth sector, hereinafter called insertion intermediate sector “S5”, along which sector the injection tube 36 moves from its retracted axial position “P0” as far as its active axial position “P1”.

This insertion intermediate sector “S5” extends, for example, over approximately 25°. Thus, the first intermediate step “E1” and the second intermediate step “E2” extend over approximately 50° of the 120° comprised between the initial step “Ei” and the final step “Ef”.

It is situated directly downstream of the retraction intermediate sector “S4”, which means that the carriage 40 descends back directly toward its active axial position “P1” as soon as it has reached its retracted axial position “P0”. It is notably the presence of the mobile sensing element 78 that allows this as this member allows the actuator 50 to be commanded directly to make the carriage 40 descent back toward its active axial position “P1” as soon as it has reached its retracted axial position “P0”, in order to avoid loss of time.

The mobile sensing element 78 makes it possible to check that the carriage 40 has indeed left its retracted axial position “P0”. It also makes it possible to determine the reaction time of the actuator 50 by detecting the moment at which the carriage 40 leaves its retracted axial position “P0” compared with the moment at which the command to move is sent by the electronic control unit 56 to the actuator 50.

Next, at the end of the second intermediate step “E2”, when the injection tube 36 has reached its active axial position “P1” for the second time in the complex cycle, it enters a seventh sector of its closed circuit, hereinafter called inserted intermediate sector “S6”, along which each injection tube 36 remains in its active axial position “P1”. Pressurized air is then injected into the preform 22 using the injection tube 36.

The injection nozzle 39 then emits a continuous jet of pressurized treatment gas which expels any dust contained in the preform 22 to the outside by making it rise up along the internal face 29 of the preform 22 as far as the neck 28. The dust expelled from the preform 22 is then collected by a dust extractor (not shown) so as to avoid contaminating the other preforms 22.

When the carriage 40 reaches the retraction primary sector “S3” as defined in the description of the simple cycle, the final step “Ef” is triggered, as described hereinabove.

In such a complex cycle, the pressurized air is preferably injected discontinuously between the end of the initial step “Ei” and the start of the final step “Ef”.

Here, the pressurized air is injected only when the carriage 40 is occupying its active axial position “P1”.

As a variant, the pressurized air is for example injected also during the intermediate steps “E1, E2”, for example only when the carriage slides into its retracted axial position “P0”, or only when the carriage slides into its active axial position “P1”.

As a variant, the pressurized air is injected continuously between the end of the initial step “Ei” and the start of the final step “Ef”.

It has been noted that such a complex cycle makes it possible to remove a greater quantity of dust than a simple cycle.

The presence of the mobile sensing elements 78 makes it possible to know when one of the actuators 50 does not have a response time that enables such a complex cycle to be performed correctly given the production rate of the production plant. If it does not, the dust-removal device 20 is once again commanded to perform simple cycles.

The mobile sensing elements 78 also make it possible to detect a malfunctioning of an actuator 50 and to identify which of the actuators 50 is exhibiting such a malfunction.

The mobile sensing elements 78 also make it possible, by providing the information necessary for calculating the response time of the actuators 50, to foresee the need for maintenance operations on certain actuators 50 which are considered to be too slow, for example the replacement of wearing parts.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A device for removing dust from inside preforms made of thermoplastic material by injection of treatment gas, the device comprising:
a conveying device comprising holding members for holding the preforms, the members being mobile along a closed circuit;
injection tubes, each of which is mounted on a mobile support so that the injection tubes are configured to be moved while being coincident with an associated one of the holding members along the closed circuit;
wherein each injection tube is configured to slide axially on the mobile support via a carriage that slides between an active axial position in which each injection tube is configured to be inserted into a preform carried by the associated holding member, and a retracted axial position in which the injection tube is configured to be outside of a preform carried by the associated holding member; and
wherein the device comprises mobile sensing elements for detecting a presence of an associated carriage in a determined first axial position, each mobile sensing element being mounted on the mobile support and each mobile sensing element constantly, over an entire length of the closed circuit, checking whether the associated carriage is occupying the determined first axial position.

2. The device as claimed in claim 1, wherein at least one of the mobile sensing elements detects a presence of the carriage in the retracted axial position.

3. The device as claimed in claim 1, wherein at least one of the mobile sensing elements detects a presence of the carriage in an intermediate axial position between the active axial position and the retracted axial position.

4. The device as claimed in claim 1, wherein at least one of the mobile sensing elements detects a presence of the carriage in the active axial position.

5. The device as claimed in claim 1, wherein each carriage is controlled by an associated independent actuator.

6. The device as claimed in claim 1, wherein a plurality of injection tubes are fixed on each carriage.

7. The device as claimed in claim 1, wherein the device comprises a fixed sensing element for detecting a presence of each carriage in a determined axial position when the carriages enter a detection zone of the closed circuit.

8. The device as claimed in claim 7, wherein the fixed sensing element detects a presence of each carriage in the active axial position.

9. The device as claimed in claim 1, wherein the retracted axial position is fixed, whereas the active axial position is adjustable according to a model of preform being processed by the device.

10. A method for removing dust from inside a preform, the method comprising at least:
providing a device for removing dust from inside preforms made of thermoplastic material by injection of treatment gas, the device comprising:
a conveying device comprising holding members for holding the preforms, the members being mobile along a closed circuit;
injection tubes, each of which is mounted on a mobile support so that the injection tubes are configured to be moved while being coincident with an associated one of the holding members along the closed circuit;
wherein each injection tube is configured to slide axially on the mobile support via a carriage that slides between an active axial position in which each injection tube is configured to be inserted into a preform carried by the associated holding member, and a retracted axial position in which the injection tube is configured to be outside of a preform carried by the associated holding member; and
wherein the device comprises mobile sensing elements for detecting a presence of an associated carriage in a determined first axial position, each mobile sensing element being mounted on the mobile support and each mobile sensing element constantly, over an entire length of the closed circuit, checking whether the associated carriage is occupying the determined first axial position;
wherein the method comprises:
an initial step of commanding the carriage carrying the injection tube associated with the preform to move into its active axial position in which the injection tube is inserted into the preform carried by the holding member; and
a final step of commanding the carriage carrying the injection tube associated with the preform to move into its retracted axial position in which the injection tube is completely extracted from the preform carried by the holding member.

11. The method as claimed in claim 10, wherein the method further comprises at least the following steps inserted chronologically after the initial step and before the final step:
a first intermediate step of commanding the carriage carrying the injection tube associated with the preform to move into its retracted axial position in which the injection tube is completely extracted from the preform carried by the holding member; and
a second intermediate step of commanding the carriage carrying the injection tube associated with the preform to move into its active axial position in which the injection tube is inserted into the preform carried by the holding member.

12. The method as claimed in claim 11, wherein pressurized air is injected into the preform using the injection tube at an end of the initial step.

13. The method as claimed in claim 12, wherein the pressurized air is injected continuously up to a start of the final step.

14. The method as claimed in claim 12, wherein the pressurized air is injected discontinuously between the end of the initial step and a start of the final step.

15. The method as claimed in claim 14, wherein the pressurized air is injected only when the carriage is occupying its active axial position.
